(19) United States
(12) Patent Application Publication
(10) Pub. No.: US 2022/0067601 A1
(43) Pub. Date: Mar. 3, 2022

(54) ADAPTIVE RISK MITIGATION

(71) Applicant: International Business Machines Corporation, Armonk, NY (US)

(72) Inventors: Seng Chai Gan, Ashburn, VA (US); Shikhar Kwatra, Raleigh, NC (US); Adam Lee Griffin, Dubuque, IA (US); Mauro Marzorati, Lutz, FL (US); Seda Ozses, Vienna (AT)

(21) Appl. No.: 17/008,696

(22) Filed: Sep. 1, 2020

(51) Int. Cl. G06Q 10/06; H04W 4/021

(52) U.S. Cl. CPC G06Q 10/0635; H04W 4/022

(57) ABSTRACT

Embodiments of the present invention provide a computer system, a computer program product, and a method that comprises generating a risk score by assigning values to at least one contextual factor of a plurality of contextual factors and aggregating the assigned values using a determination engine; creating a geo-fence by establishing geographical boundaries proportional to the generated risk score; and dynamically recalculating the generated risk score based on an identified change to the at least one contextual factor of the plurality of contextual factors.

### FIELD OF INVENTION

The present invention relates generally to the field of risk mitigation technology, and more specifically adaptatively tracking an asset.

### BACKGROUND

Global positioning systems (“GPS”) are satellite-based radio navigation systems that provide geolocation and time information to a receiver anywhere on or near the surface of Earth where is an unobstructed line of sight to multiple satellites. Obstacles block relatively weak signals, and examples of obstacles are mountains and buildings. GPS do not require a user to transmit any data, and it operates independently of any telephonic or internet reception, though these technologies can enhance the usefulness of the GPS positioning information.

Geolocation is the identification or estimation of the real-world geographic location of an object, such as a radar source, mobile phone, or internet-based computer terminal. Geolocation involves the generation of a set of geographic coordinates and is closely related to the use of positioning system, but its usefulness is enhanced by the use of these coordinates to determine a meaningful location, such as a street address. The word geolocation refers to the latitude and longitude coordinates of a particular location. The term and definition have been standardized by a real-time locating system.

Risk management is the identification, evaluation, and prioritization of risks followed by coordinated and economical application of resources to minimize, monitor, and control the probability or impact of unfortunate events or to maximize the realization of opportunities. Risk management standards have been developed by various intuitions. Strategies to manage threats typically include avoiding the threat, reducing the effect or probability of the threat, transferring the threat to another party, and retaining some of the consequences of a particular threat.

### SUMMARY

Embodiments of the present invention provide a computer system, a computer program product, and a method that comprises generating a risk score by assigning values to at least one contextual factor of a plurality of contextual factors and aggregating the assigned values using a determination engine; creating a geo-fence by establishing geographical boundaries proportional to the generated risk score; and dynamically recalculating the generated risk score based on an identified change to the at least one contextual factor of the plurality of contextual factors.

### BRIEF DESCRIPTION OF THE DRAWINGS

FIG. 1 is a functional block diagram depicting an environment with a computing device connected to or in communication with another computing device, in accordance with at least one embodiment of the present invention;

FIG. 2 is a flowchart illustrating operational steps for generating an adaptive geo-fencing, in accordance with at least one embodiment of the present invention;

FIG. 3 is a flowchart illustrating operational steps for calculating a risk score, in accordance with at least one embodiment of the present invention; and

FIG. 4 depicts a block diagram of components of computing systems within a computing display environment of FIG. 1, in accordance with an embodiment of the present invention.

### DETAILED DESCRIPTION

Embodiments of the present invention recognize the need for an improvement to risk mitigation systems by using geo-fencing technology and adaptive assessment algorithms to determine a risk level for a particular asset. Embodiments of the present invention provide systems, methods, and computer program products for an improvement to risk mitigation technologies known in the art. Currently, risk mitigation technologies require manual user input. Typically, risk mitigation technologies when used with monitoring and location technologies are proactive system that are able to minimize, monitor, and control based on manually input information. This manual input allows for error and abuse of the risk mitigation technology, leading to a form of fraud. Furthermore, risk mitigation when used in conjunction with monitoring and location technologies is reactive measures of the technology. Improvements using dynamic monitoring of location and usage based on a predetermined fixed amount of time of an asset combined with an adaptive calculation of risk on an specific asset basis is a solution to generate an adaptive geo-fence that monitors the location and usage of an asset and automatically transmits this data to server for compilation and generation of a displayable model. Embodiments of the present invention generates an adaptive geo-fence that dynamically provides a location and usage amounts of an asset by receiving information associated with the asset and the user, generating a risk score based on the received information, creating a geo-fence, wherein the area of the created geo-fence is based on the generated risk score, and dynamically recalculating the risk score based on newly received information associated with the created geo-fence to update the geo-fence without the need of manual input.

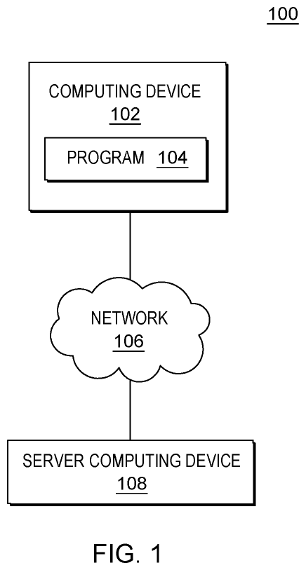

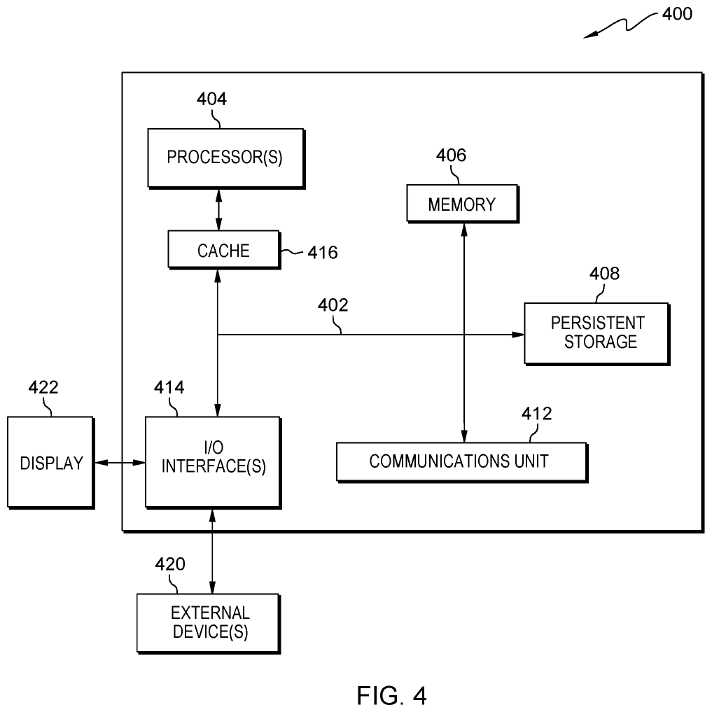

FIG. 1 is a functional block diagram of a computing environment 100 in accordance with an embodiment of the present invention. The computing environment 100 includes a computing device 102 and a server computing device 108. The computing device 102 and the server computing device 108 may be desktop computers, laptop computers, specialized computer servers, smart phones, wearable technology, or any other computing devices known in the art. In certain embodiments, the computing device 102 and the server computing device 108 may represent computing devices utilizing multiple computers or components to act as a single pool of seamless resources when accessed through a network 106. Generally, the computing device 102 and the server computing device 108 may be representative of any electronic devices, or a combination of electronic devices, capable of executing machine-readable program instructions, as described in greater detail with regard to FIG. 4.

The computing device 102 may include a program 104. The program 104 may be a stand-alone program on the computing device 102. In another embodiment, the program 104 may be stored on a server computing device 108. In this embodiment, the program 104 generates an adaptive geo-fence that locates an asset using geographical positioning systems (“GPS”), monitors the usage of an asset by tracking a predetermined variable associated with usage of an asset, (i.e., time, mileage, battery life, etc.) and transmits information associated with the asset (e.g., the asset's location and the monitored usage of the asset) to a computing device 102.

In another embodiment, the program 104 receives information, wherein the information is associated with an asset and a user; calculates a risk score by assigning values to multiple factors of the received information and generating an initial risk score by aggregating the assigned values of the multiple factors of the received information; creates an initial geo-fence by establishing a virtual boundary encompassing a predetermined area based on the calculated risk score and monitoring movements of the asset within the established virtual boundary, dynamically recalculates the risk score by continually monitoring the usage and location of the asset within the created geo-fence, receiving new information based on the monitored usage and location of the asset, and calculating a second risk score by aggregating the initial risk score and assigned values of multiple factors associated with the new received information; and creates a final geo-fence based on the recalculated risk score by modifying the area within the virtual boundary based on the recalculated risk score. For example, when the recalculated risk score is a larger number than the initial risk score, then the program 104 decrease the area of the geo-fence to restrict the movement and usage of the asset based on the increase in risk score. In this embodiment, the asset is a leased good or service. For example, the asset is a scooter that a user may rent on an hourly basis, or the asset is a car that is on a 72-month lease. In this embodiment, information is defined as data forming part of a database. For example, information is the user's income, job history, net-income, credit history, credit ratings, interest rates, liquidity, purchase history, banking assets, real-estate assets, geo-fence of the credit card, timestamp of the typical financial transactions throughout the day. In another example, information is the user's social media profile, social media history, internet presence bank records, telephone records, and billing statements to identify the identity of the user. In another embodiment, the program 104 receives manual input from the user to access the user's personal information. In another example, information may be associated with the asset, such as the make, model, and year of a vehicle.

The network 106 can be a local area network (“LAN”), a wide area network (“WAN”) such as the Internet, or a combination of the two; and it may include wired, wireless or fiber optic connections. Generally, the network 106 can be any combination of connections and protocols that will support communication between the computing device 102 and the server computing device 108, specifically the program 104 in accordance with a desired embodiment of the invention.

The server computing device 108 may include the program 104 and may communicate with the computing device 102 via the network 106. The server computing device 108 may be a single computing device, a laptop, a cloud-based collection of computing devices, a collection of servers, and other known computing devices. In this embodiment, the server computing device 108 may be in communication with the user's wearable computing device.

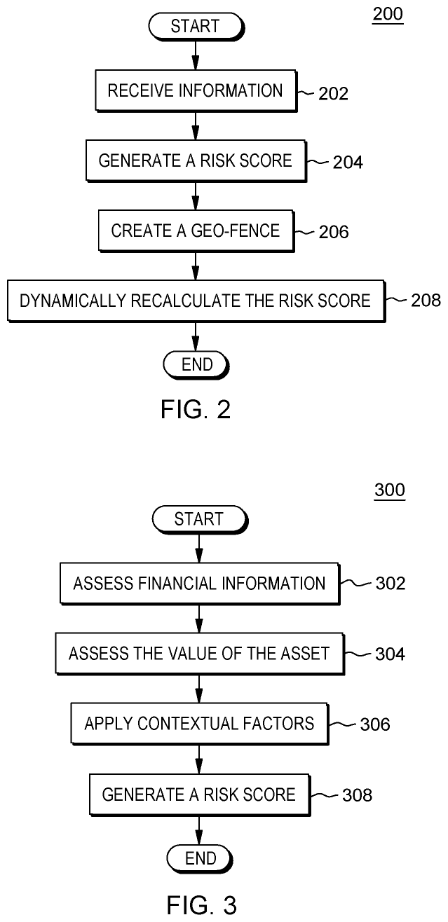

FIG. 2 a flowchart 200 illustrating operational steps for dynamically mitigating risk using geo-fencing, in accordance with at least one embodiment of the present invention.

In step 202, the program 104 receives information. In this embodiment, the program 104 receives information by interpreting code from an external source (e.g., server computing device 108 or a user) and storing the interpreted code as data by transmitting instruction to communicate with input, output, and storage devices. In this embodiment, the program 104 receives opt-in/opt-out permission from a user that is linked to the computing device 102. In this embodiment and in response to receiving information, the program 104 generates a database based on the received information that is collected and associated with a specific asset and a specific user. For example, the program 104 receives information in the form of user's income, job history, net-income, credit history, credit ratings, interest rates, liquidity, purchase history, banking assets, real-estate assets, geo-fence of the credit card, timestamp of the typical financial transactions throughout the day. In another example, the program 104 may receive information in the form of a user's social media profile, social media history, internet presence bank records, telephone records, and billing statements to identify the identity of the user. In another embodiment, the program 104 receives manual input from the user to access the user's personal information.

In step 204, the program 104 generates a risk score. In this embodiment and in response to receiving information, the program 104 generates a risk score by assigning values to multiple factors of the received information and generating an initial risk score by aggregating the assigned values of the multiple factors of the received information using a determination engine. In this embodiment, the program 104 assigns values to multiple factors by identifying factors within the received information that has an effect on a lending institutions decision to allow a user to rent or lease the asset. For example, a user's credit history is identified as a factor that would affect a car dealership's decision to provide a leased vehicle to the user. In this embodiment and in response to identifying factors, the program 104 assigns values to the multiple factors by quantifying each factor's effect, where the larger the effect, the higher the value given to the respective factor. For example, the program 104 identifies credit score and the income of the user, and the program 104 assigns a higher quantitative value to the user's credit than the user's income because the user's credit score is viewed as more important of a factor to the car dealerships decision to lease the vehicle. In this embodiment, the assigned values may have a positive numerical value or a negative numerical value. In this embodiment and in response to assigning values to the multiple factors, the program 104 adds (i.e., aggregates) the assigned values to the multiple factors by summing all of the assigned values to calculate an initial risk score. In this embodiment, the program 104 generates a scale for calculated risk scores from 1 to 5, where 5 is a maximum risk score and 1 is a minimum risk score. For example, the program 104 adds the value of the user's credit score of a 2 and the user's income of 1 to calculate an initial risk score of 3.

In this embodiment, the program 104 generates a risk score using a determination engine. In this embodiment, the determination engine automates decisions of the computing device 102 by taking the received information or other data and converting that information and data into computer-generated problem solving algorithmic values capable of being added, subtracted, divided, multiplied, and compiled into a graphic display within the computing device 102. In this embodiment, the program 104 uses the determination engine to quantify the multiple factors with assigned quantitative values. For example, the program 104 uses the determination engine to assign a score for each form of information associated with the asset and the user and generate a table of these scores within an application within a smart phone.

In another embodiment, the program 104 generates a risk score by assessing financial information associated with an asset and a user, quantifying a value of the asset, applying multiple contextual factors associated with the asset, and combining the multiple values to produce an overall score. This step will be further discussed in FIG. 3.

In this embodiment, the program 104 assesses financial information associated with an asset and a user by analyzing the received information using the determination engine to convert any received information associated with the asset or the user into quantitative data to be used to generate a risk score. For example, the program 104 analyzes the user's credit score, and converts that information into a numerical price limit using the determination engine.

In this embodiment and in response to assessing financial information associated with the asset and the user, the program 104 assesses an asset's value. In this embodiment, the program 104 quantifies the asset's value by performing a query on the asset. The program 104 performs the query by searching external computing devices using machine learning algorithms to retrieve information detailing the asset's value, quantifying the retrieved information using the determination engine to convert the information into quantitative data, and quantifying the asset's value by summing the quantitative data associated with the asset. For example, the program 104 retrieves the price for the vehicle by performing a query on a car trading website and converts that price into a quantified value using the determination engine.

In this embodiment and in response to quantifying the asset's value, the program 104 applies contextual factors associated with the asset and the user. In this embodiment, the program 104 applies contextual factors associated with the asset and the user to the quantified values of the financial information and the asset's value. In this embodiment, contextual factors are defined as any factor that would affect a lender's decision in renting or leasing any property to another. For example, contextual factors include income, job history, net-income, credit history, credit ratings, interest rates, liquidity, purchase history, banking assets, and real estate assets. In this embodiment, the program 104 uses the determination engine to convert the application of these contextual factors into a quantitative value that may be used to generate a risk score. In this embodiment, some contextual factors may mitigate an increasing risk score and may lower a risk score. Examples of mitigating contextual factors include an increase in income, removal of debt, increased credit score, and improvement in credit payment history.

In this embodiment and in response to applying the contextual factors, the program 104 generates a risk score by combining the quantitative values. In this embodiment, the program 104 aggregates (e.g., adds) the quantitative values associated with the financial information, the quantitive values associated with the value of the asset, and the quantitative values associated with the applied contextual factors to generate an overall risk score. For example, the program 104 adds the value of the user's credit score as 3, the value of the car as 4, and the value of the contextual factors as 1 for an overall risk score of 8.

In another embodiment, the program 104 generates an overall confidence score based on the multiple factors associated with the received information. The overall confidence score is defined as a quantitative risk associated with a user's purchase request based on the multiple assessed factors. For example, the program 104 outputs a risk score of low risk based on the user having a steady income of a six-figure salary and user is purchasing an affordable automobile.

In step 206, the program 104 creates a geo-fence. In this embodiment and in response to generating the risk score, the program 104 creates a geo-fence by establishing geographical boundaries using global positioning algorithms, and the size of the established geographical boundary is directly associated with the generated risk score. In this embodiment, the larger the risk score then the smaller the established geographical boundary. For example, user A has a risk score of 9 and user B has a risk score of 3, and both user A and user B are leasing an identical car with an identical value. In this example, the program 104 configures a larger geo-fence for user B than user A because user B has a quantifiable lower risk to the value of the asset.

In this embodiment, the program 104 creates the geo-fence to track the movements of the asset in real time using GPS algorithms and generate notifications that alert in the event that the asset passes the established geographical boundaries or has been used beyond a predetermined amount based on the generated risk score. In this embodiment, the program 104 creates the geo-fence to connect to a specific asset. The geo-fence is configured to secure an asset's geographically approved boundaries. In another embodiment, the program 104 configures the geo-fence to coordinate with a usage tracker to monitor the location of the asset and the amount of usage of the asset. For example, the program 104 configures a geo-fence encompassing an entire state to ensure that the asset does not leave that state. In another embodiment, the program 104 may receive input from the user to manually configure the geo-fence.

In step 208, the program 104 dynamically recalculates the risk score. In this embodiment, the program 104 dynamically recalculates the risk score by analyzing the risk score determined by the determination engine, modifying the created geo-fence, and recalculating the risk score based on the quantitative values associated with the user's financial information, the asset's value, and the modified created geo-fence. The step is further explained in FIG. 3.

In this embodiment, the program 104 analyzes the risk score based on determination engine's determination. In this embodiment, the program 104 analyzes a first risk score determined by the determination engine by identifying a user's risk score, identifying the assets value, recalculating a first risk score by adding and subtracting changes based on the application of contextual factors, and verifying the first risk score by comparing the recalculated risk score to the first risk score. For example, the program 104 analyzes the first risk score for user A as low risk; and after changes in the user's credit history, recalculates the risk score for user A as a medium risk.

In this embodiment, the program 104 modifies the created geo-fence by identifying a first created geo-fence based on the first risk score, identifying a second created geo-fence based on the recalculated risk score, and modifying the geo-fence based on the difference between the first created geo-fence and the second created geo-fence. In this embodiment, the program 104 determines the difference between the two created geo-fences by measuring the area that each geo-fence encompasses. In this embodiment, the program 104 compares any differences between the first created geo-fence and the second configured geo-fences by calculating the amount of area encompassed by each created geo-fence. In this embodiment, the program 104 modifies the created geo-fence based on the risk score, which may increase the area of the geo-fence, decrease the area of the geo-fence, or the usage of the asset. In this embodiment, the program 104 creates the geo-fence by establishing geographical boundaries proportional to the calculated risk score. In another embodiment, the program 104 transmits an alert in response to the use of the asset triggering an established boundary of the created geo-fence, throttles down the use of the asset between an established boundary of the created geo-fence and the actual boundary of the created geo fence; and terminates the use of the asset in response to the asset crossing the actual boundary of the created geo-fence.

In this embodiment, the program 104 recalculates the risk score based on the determination engine's risk score and new data that has the ability to alter the risk score such as new financial information, over-use of an asset, and taking an asset past the configured geo-fence. In this embodiment and in response to modifying the created geo-fence, the program 104 dynamically recalculates the risk score by continually receiving data that affects a user's risk score; in response to receiving data that changes the user's risk score, automatically recalculating the risk score based on the received data as in step 208; in response to automatically recalculating the risk score, reconfiguring the geo-fence associated with the risk score; and in response to reconfiguring the geo-fence, automatically updating a database that stores risk scores and configured geo-fences for multiple users. For example, the program 104 automatically updates the risk score for user A based on breach of a created geo-fence and a missed credit card payment; thus, the updated risk score is higher based on the received information of user A. In this example, a derogatory mark of risk will increase a user's risk score and will be considered a contextual factor of the calculation.

FIG. 3 is a flowchart 300 illustrating operational steps for generating the risk score, in accordance with at least one embodiment of the present invention.

In step 302, the program 104 assesses financial information. In this embodiment, the program 104 assesses financial information associated with the user and the asset from the received information by identifying financial information within the received information and converting the financial information into quantitive data that may be used to calculate a risk score using the determination engine as previously discussed. For example, the program 104 assesses the user's credit score and the user's income from the received information and quantifies the credit score as a 2 and the income as a −1. This is because the user's income is above six figures annual salary.

In step 304, the program 104 assesses the value of the asset. In this embodiment and in response to assessing financial information, the program 104 assesses the value of the asset. In this embodiment, the program 104 assesses the asset's value by performing a query on a particular asset. The program 104 performs the query by searching the internet using machine learning algorithms to retrieve information detailing the asset's value. Examples of information that details the asset's value are retail value, purchase price, accident risk, and damage risk. In another embodiment, the program 104 retrieves information from the Office of the Comptroller of Currency to assess the asset's value. In another embodiment, the program 104 performs the query by searing the internet to retrieve risk types of the asset. Examples of risk types are strategic, compliance, reputational, and operational. For example, the program 104 assesses a car's value based on its retail price, purchase price, and resale price.

In step 306, the program 104 applies contextual factors. In this embodiment and in response to quantifying the asset's value, the program 104 applies contextual factors associated with the asset and the user. In this embodiment, the program 104 applies contextual factors associated with the asset and the user to the quantified values of the financial information and the asset's value by assigning weights to each contextual factor based on a measured quantitative impact of each contextual factors. For example, the program 104 a user's six-figure income has an assigned weight of negative three (−3) based on this contextual factor's measured quantitative impact, and a missed credit card payment has an assigned weight of positive one (1) based on this contextual factor's measured quantitative impact. In this embodiment and in response to assigning weights to each contextual factor, the program 104 applies contextual factors by aggregating the assigned weights of each contextual factor, wherein mitigating contextual factors are assigned negative weights. For example, the program 104 aggregates the assigned weights −3 and 1 resulting in an aggregated assigned weight of −2 for the user. In this embodiment and in response to aggregating the assigned weights, the program 104 applies contextual factors by determining an order of the measured quantitive impact of each contextual factor by organizing the assigned weights of each contextual factor to place the assigned weights with a higher value in a higher order than the assigned weights with a lesser value. For example, the program 104 places the user's six figure income at a first position and the user's missed credit card payment at a second position because the user's six figure income has a higher assigned weight than the user's missed credit card payment.

In this embodiment, contextual factors are defined as any factor that would affect a lender's decision in renting or leasing any property to another. For example, contextual factors include income, job history, net-income, credit history, credit ratings, interest rates, liquidity, purchase history, banking assets, and real estate assets. In this embodiment, the program 104 uses the determination engine to convert the application of these contextual factors into a quantitative value that may be used to generate a risk score. In this embodiment, some contextual factors may mitigate an increasing risk score and may lower a risk score. Examples of mitigating contextual factors include an increase in income, removal of debt, increased credit score, and improvement in credit payment history.

In step 308, the program 104 generates a risk score. In this embodiment and in response to applying the contextual factors, the program 104 generates a risk score by combining the quantitative values. In this embodiment, the program 104 aggregates (e.g., adds) the quantitative values associated with the financial information, the quantitive values associated with the value of the asset, and the quantitative values associated with the applied contextual factors to generate an overall risk score. For example, the program 104 adds the value of the user's credit score as 3, the value of the car as 4, and the value of the contextual factors as 1 for an overall risk score of 8.

FIG. 4 depicts a block diagram of components of computing systems within a computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

A computer system 400 includes a communications fabric 402, which provides communications between a cache 416, a memory 406, a persistent storage 408, a communications unit 412, and an input/output (I/O) interface(s) 414. The communications fabric 402 can be implemented with any architecture designed for passing data and/or control information between processors (such as microprocessors, communications and network processors, etc.), system memory, peripheral devices, and any other hardware components within a system. For example, the communications fabric 402 can be implemented with one or more buses or a crossbar switch.

The memory 406 and the persistent storage 408 are computer readable storage media. In this embodiment, the memory 406 includes random access memory (RAM). In general, the memory 406 can include any suitable volatile or non-volatile computer readable storage media. The cache 416 is a fast memory that enhances the performance of the computer processor(s) 404 by holding recently accessed data, and data near accessed data, from the memory 406.

The program 104 may be stored in the persistent storage 408 and in the memory 406 for execution by one or more of the respective computer processors 404 via the cache 416. In an embodiment, the persistent storage 408 includes a magnetic hard disk drive. Alternatively, or in addition to a magnetic hard disk drive, the persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by the persistent storage 408 may also be removable. For example, a removable hard drive may be used for the persistent storage 408. Other examples include optical and magnetic disks, thumb drives, and smart cards that are inserted into a drive for transfer onto another computer readable storage medium that is also part of the persistent storage 408.

The communications unit 412, in these examples, provides for communications with other data processing systems or devices. In these examples, the communications unit 412 includes one or more network interface cards. The communications unit 412 may provide communications through the use of either or both physical and wireless communications links. The program 104 may be downloaded to the persistent storage 408 through the communications unit 412.

The I/O interface(s) 414 allows for input and output of data with other devices that may be connected to a mobile device, an approval device, and/or the server computing device 108. For example, the I/O interface 414 may provide a connection to external devices 420 such as a keyboard, keypad, a touch screen, and/or some other suitable input device. External devices 420 can also include portable computer readable storage media such as, for example, thumb drives, portable optical or magnetic disks, and memory cards. Software and data used to practice embodiments of the present invention, e.g., the program 104, can be stored on such portable computer readable storage media and can be loaded onto the persistent storage 408 via the I/O interface(s) 414. The I/O interface(s) 414 also connect to a display 422.

The display 422 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
retrieving information associated with a user and a respective asset associated with the user;
determining at least one contextual factor from a plurality of contextual factors within the retrieved information, wherein the at least one contextual factor represents a breach of a boundary of a geo-fence;
generating a risk score by assigning values to the at least one contextual factor of the plurality of contextual factors and aggregating the assigned values;
creating the geo-fence by establishing geographical boundaries proportional to the generated risk score;
dynamically recalculating the generated risk score based on an identified change to the at least one contextual factor of the plurality of contextual factors;
generating a displayable model that provides a location of the respective asset and the recalculated generated risk score for the respective asset within the created geo-fence; and
modifying the created geo-fence based on the recalculated generated risk score, wherein modifying the created geo-fence includes increasing an area of the created geo-fence based, at least in part, on the recalculated generated risk score being less than the generated risk score.

2. The computer-implemented method of claim 1, wherein generating the risk score comprises:
assigning values to the at least one identified contextual factor and to at least one additional factor using a determination engine, wherein the determination engine converts the assigned values into respective computer-generated problem-solving algorithmic values; and
calculating an initial risk score by summing the assigned values of the at least one identified contextual factors and the at least one additional factor.

3. The computer-implemented method of claim 1 further comprising:
assessing financial information associated with a user by converting received information associated with the user into quantitative data;
in response to assessing the financial information associated with the user, assessing an asset's value by performing a query on an asset;
applying contextual factors associated with the assessment of the financial information associated with the user and the assessment of the asset; and
generating a risk score by aggregating a quantitative value associated with the assessed financial information, the assessed asset value, and the at least one contextual factor of the plurality of contextual factors.

4. The computer-implemented method of claim 1, wherein dynamically recalculating the generated risk score comprises:
receiving additional information associated with the plurality of contextual factors; and
recalculating the generated risk score by summing the assigned values of the received additional information associated with the identified change in at least one contextual factor in the plurality of contextual factors.

5. (canceled)

6. The computer-implemented method of claim 1 further comprising generating an alert notification in response to the asset leaving an established geographical boundary, wherein the established geographical boundary is a border of the created geo-fence.

7. The computer-implemented method of claim 1 further comprising:
configuring the created geo-fence to communicate with the asset in real time;
transmitting an alert to a computing device in response to a use of the asset triggering an established boundary of the created geo-fence;
throttling down a use of the asset in the area between a predetermined distance from the established boundary of the created geo-fence and the established boundary of the created geo-fence; and
in response to the asset exceeding the established boundary of the created geo-fence, remotely terminating the use of the asset.

8. A computer program product comprising:
one or more computer readable storage media and program instructions stored on the one or more computer readable storage media, the program instructions comprising:
program instructions to retrieve information associated with a user and a respective asset associated with the user;
program instructions to determine at least one contextual factor from a plurality of contextual factors within the retrieved information, wherein the at least one contextual factor represents a breach of a boundary of a geo-fence;
program instructions to generate a risk score by assigning values to the at least one contextual factor of the plurality of contextual factors and aggregating the assigned values;
program instructions to create the geo-fence by establishing geographical boundaries proportional to the generated risk score;
program instructions to dynamically recalculate the generated risk score based on an identified change to the at least one contextual factor of the plurality of contextual factors program instructions to generate a displayable model that provides a location of the respective asset and the recalculated generated risk score for the respective asset within the created geo-fence; and
program instructions to modify the created geo-fence based on the recalculated generated risk score, wherein modifying the created geo-fence includes increasing an area of the created geo-fence based, at least in part, on the recalculated generated risk score being less than the generated risk score.

9. The computer program product of claim 8, wherein the program instructions to generate the risk score comprise:
program instructions to assign values to the at least one identified contextual factor and to at least one additional factor using a determination engine, wherein the determination engine converts the assigned values into respective computer-generated problem-solving algorithmic values; and
program instructions to calculate an initial risk score by summing the assigned values of the at least one identified contextual factors and the at least one additional factor.

10. The computer program product of claim 8, wherein the program instructions stored on the one or more computer readable storage media further comprise:
program instructions to assess financial information associated with a user by converting received information associated with the user into quantitative data;
in response to program instructions to assess the financial information associated with the user, program instructions to assess an asset's value by performing a query on an asset;
program instructions to apply contextual factors associated with the assessment of the financial information associated with the user and the assessment of the asset; and
program instructions to generate a risk score by aggregating a quantitative value associated with the assessed financial information, the assessed asset value, and the at least one contextual factor of the plurality of contextual factors.

11. The computer program product of claim 8, wherein the program instructions to dynamically recalculate the generated risk score comprise:
program instructions to receive additional information associated with the plurality of contextual factors; and
program instructions to recalculate the generated risk score by summing the assigned values of the received additional information associated with the identified change in at least one contextual factor in the plurality of contextual factors.

12. (canceled)

13. The computer program product of claim 8, wherein the program instructions stored on the one or more computer readable storage media further comprise:
program instructions to generate an alert notification in response to the asset leaving an established geographical boundary, wherein the established geographical boundary is a border of the created geo-fence.

14. The computer program product of claim 8, wherein the program instructions stored on the one or more computer readable storage media further comprise:
program instructions to configure the created geo-fence to communicate with the asset in real time;
program instructions to transmit an alert to a computing device in response to a use of the asset triggering an established boundary of the created geo-fence;
program instructions to throttle down a use of the asset in the area between a predetermined distance from the established boundary of the created geo-fence and the established boundary of the created geo-fence; and
in response to the asset exceeding the established boundary of the created geo-fence, program instructions to remotely terminate the use of the asset.

15. A computer system comprising:
one or more computer processors;
one or more computer readable storage media; and
program instructions stored on the one or more computer readable storage media for execution by at least one of the one or more processors, the program instructions comprising:
program instructions to retrieve information associated with a user and a respective asset associated with the user;
program instructions to determine at least one contextual factor from a plurality of contextual factors and at least one additional factor from the retrieved information, wherein the at least one contextual factor represents a breach of a boundary of a geo-fence;
program instructions to generate a risk score by assigning values to the at least one contextual factor of the plurality of contextual factors and aggregating the assigned values;
program instructions to create the geo-fence by establishing geographical boundaries proportional to the generated risk score;
program instructions to dynamically recalculate the generated risk score based on an identified change to the at least one contextual factor of the plurality of contextual factors;
program instructions to generate a displayable model that provides a location of the respective asset, a usage value for the respective asset, and the recalculated generated risk score for the respective asset within the created geo-fence; and
program instructions to modify the created geo-fence based on the recalculated generated risk score, wherein modifying the created geo-fence includes increasing an area of the created geo-fence based, at least in part, on the recalculated generated risk score being less than the generated risk score.

16. The computer system of claim 15, wherein the program instructions to generate the risk score comprise:
program instructions to assign values to the at least one identified contextual factor and to at least one additional factor using a determination engine, wherein the determination engine converts the assigned values into respective computer-generated problem-solving algorithmic values; and
program instructions to calculate an initial risk score by summing the assigned values of the at least one identified contextual factors and the at least one additional factor.

17. The computer system of claim 15, wherein the program instructions stored on the one or more computer readable storage media further comprise:
program instructions to assess financial information associated with a user by converting received information associated with the user into quantitative data;
in response to program instructions to assess the financial information associated with the user, program instructions to assess an asset's value by performing a query on an asset;
program instructions to apply contextual factors associated with the assessment of the financial information associated with the user and the assessment of the asset; and
program instructions to generate a risk score by aggregating a quantitative value associated with the assessed financial information, the assessed asset value, and the at least one contextual factor of the plurality of contextual factors.

18. The computer system of claim 15, wherein the program instructions to dynamically recalculate the generated risk score comprise:
program instructions to receive additional information associated with the plurality of contextual factors; and
program instructions to recalculate the generated risk score by summing the assigned values of the received additional information associated with the identified change in at least one contextual factor in the plurality of contextual factors.

19. (canceled)

20. The computer system of claim 15, wherein the program instructions stored on the one or more computer readable storage media further comprise:
program instructions to generate an alert notification in response to the asset leaving an established geographical boundary, wherein the established geographical boundary is a border of the created geo-fence.
